(19) United States
(12) Patent Application Publication
(10) Pub. No.: US 2019/0071245 A1
(43) Pub. Date: Mar. 7, 2019

(54) PACKAGING SYSTEM FOR A CURABLE MULTI-COMPONENT MASS, USE OF SAID PACKAGING SYSTEM TO PROCESS THE CURABLE MULTI-COMPONENT MASS, AND METHOD FOR PRODUCING A CURABLE MULTI-COMPONENT MASS

(71) Applicant: Hilti Aktiengesellschaft, Schaan (LI)

(72) Inventors: Mario PAETOW, Igling (DE); Jekaterina MILLER, Augsburg (DE); Friedemann SETZER, Schwabmuenchen (DE); Tanina KABECHE, Muenchen (DE); Erica OLSCHNOEGGER, Schellenberg (LI)

(73) Assignee: Hilti Aktiengesellschaft, Schaan (LI)

(21) Appl. No.: 16/084,256

(22) PCT Filed: Mar. 13, 2017
(86) PCT No.: PCT/EP2017/055771

§ 371 Date: Sep. 12, 2018

(30) Foreign Application Priority Data
Mar. 15, 2016 (EP) 16160359.2

(51) Int. Cl. B65D 85/816; B65D 75/58

(52) U.S. Cl. CPC B65D 85/816; C04B 28/04; B65D 75/5872

(57) ABSTRACT

A packaging system can process a curable multi-component mass. The packaging system includes a plastic container, and a reactive component of the multi-component mass, which is present in the plastic container. The plastic container is a foldable plastic container with at least one closable opening, and the reactive component is present as powder and fills only part of a total volume of the plastic container.

The invention relates to a packaging system for a curable multi-component mass and to the use of the packaging system to process the curable multi-component mass. Furthermore, the invention relates to a method for producing a curable multi-component mass, especially a foam-in-place foam and preferably an inorganic fire-protection foam.

For rapid sealing of openings, such as fire-protection penetrations in the building sector, for example, or for anchoring of building parts in boreholes, a reactive material of two components is mixed in place and introduced into the opening. Depending on the desired application, the reactive material may be stable until it cures and not flow back out of the opening. This is the case in particular for wall openings. For ceiling openings, in contrast, it may be desirable for the reactive material to have a certain flowability.

In two-component masses comprising liquid resins such as polyurethane or epoxy resins, stability is achieved by appropriate adjustment of the viscosity of the material. The reactive components are introduced separately into two-component cartridges with a static mixer and are mixed at the point of application by expelling them from the cartridge in the static mixer. Static mixers are not suitable for mixtures of powder components and liquids, however, because bridging takes place in the powder component and, because of pressure, prevents mixing in the static mixer.

Masses consisting of powders and liquids therefore are mechanically mixed with one another in an open vessel using a stirring rod or other mixing aids. The mixed mass may then be introduced manually into the opening to be filled and/or transformed to the desired shape, or are filled into further application aids, such as a kneading press, for example, and introduced into the opening.

If a powder is to be mixed with liquid in a rigid, closed container, further aids such as balls, for example, are needed in a space partly filled with air. A substantially liquid consistency of the mixture is necessary for emptying the container.

Multi-component systems for producing gypsum foams and/or cement foams by mixing in open vessels are known, for example, from EP 2 045 227 A. The hydraulically binding composition described therein is used for producing inorganic fire-protection or insulating foam-in-place foams. It comprises a pH-neutral or alkaline hydraulic binder and a foaming component as well as a foam stabilizer, wherein the foaming component releases oxygen or carbon dioxide. However, the known inorganic fire-protection systems can be introduced into openings only with difficulty and are frequently usable only as a grouting mass with complex formwork devices.

Furthermore, liquid two-component grouting resins are known, which are introduced in a two-chamber film bag with clamp-type closure. In this case the liquid grouting resin is mixed manually after removal of the clamp-type closure and is then poured into cable lugs, for example. Clamp-type bags are less well suited for stable masses, since the components must be mixed by manual kneading and therefore the mixing quality can be controlled and reproduced only with difficulty.

A need continues to exist for a simple and inexpensive packaging system for good mixing and application of curable multi-component masses in a closed container.

The object underlying the invention is to supply a simple, user-friendly and inexpensive form of use and packaging for good mixing and application of curable masses in a closed container, especially for chemical anchors or for an inorganic foam on the basis of gypsum or cement mortar for insulating or fire-protection purposes with solid, powdered and liquid components. The form of use should permit mixing of the components without complex tools and make it possible to introduce the mass even into openings that are narrow and/or difficult to access.

This object is solved by a packaging system according to claim 1. Subject matter of the invention is further the use of the packaging system according to claim 12 for packaging and/or processing of a curable multi-component mass, as well as a method for producing and processing a curable multi-component mass according to claim 13, preferably using the inventive packaging system.

Advantageous and expedient configurations of the inventive method and of the inventive packaging system are specified in the associated dependent claims.

The invention supplies a packaging system for a curable multi-component mass, with a plastic container, in which a reactive component of the multi-component mass is introduced, wherein the plastic container is a foldable plastic container with at least one closable opening. The reactive component exists as a powder and fills only part of a total volume of the plastic container.

The inventive packaging system makes it possible to supply a multi-component mass in various package sizes from a few hundred grams up to approximately 10 kg with a respective given quantity of the reactive component introduced into the plastic container and optionally a separately provided and/or packaged liquid hardener component for the reactive component. Thus erroneous dosing by the user can be reliably prevented and the mixture is ready for immediate use. Good mixing results can be achieved by simple shaking of the solid and liquid components in the closed plastic container.

The mixing results may be further improved by choosing the quantity of the components to be mixed in the plastic container such that an air volume remains after complete filling of the plastic container.

Alternatively or additionally, mixing elements may be introduced into the plastic container. In the case of heavy mixing elements, which may be stones, metal ball bearings or glass marbles, for example, they ensure good intermixing during shaking of the solid and liquid components in the plastic container for formation of the curable multi-component mass. Reproducibility of the mixing quality is possible by specifying the duration and/or number of shaking processes.

During mixing of the solid and liquid components in the closed plastic container, no dust generation is able to develop from the powdered reactive component. Contact of the user with the reactive component during mixing is excluded, and so a health hazard is avoided. Finally, cleaning of mixing tools and containers is also not necessary, since mixing of the components takes place inside the plastic container.

The air volume or empty volume present in the plastic container also makes it possible to supply foam-forming masses. No mixing and expelling tools are needed to discharge the curable mass from the plastic container in order to achieve good emptying of residues. Nevertheless, it is still possible to use the inventive plastic container, which may be a film bag, for example, to discharge residual quantities with a known film dispenser. Since formation of the curable mass takes place directly in the plastic container, it is not even necessary to remove any initial discharge. The opening provided in the plastic container may be configured such that the curable mass is dosed into narrow and only poorly accessible openings of the building. Moreover, the inventive packaging system also makes it possible to process stable curable masses, which remain securely in the opening to be filled and cure therein.

Although the invention is described hereinafter on the basis of a two-component system, multi-component systems, which contain more than two reactive components, are also comprised by the invention and can be implemented with little complexity.

The curable multi-component mass may comprise the reactive component introduced in powder form into the plastic container and a separately supplied hardener component.

If the hardener component consists of water, the quantity of water necessary for formation of the curable mass may be measured out on site and added to the reactive component in the plastic container. In another embodiment, the hardener component may be supplied in separate packaging and for use may be mixed on site with the reactive component in the plastic container.

According to a preferred embodiment, the curable multi-component mass is a curable organic mass, especially on the basis of epoxides, (meth)acrylates or polyurethane. In this case, the liquid hardener component may contain in particular organic amines, an aqueous peroxide solution and/or a solution of organic peroxides.

According to a further embodiment, the multi-component mass is an inorganic multi-component mass comprising a hydraulically binding component as the powdered reactive component and a water-containing component or component consisting of water as the hardener component. Cements, especially Portland cement, trass, pozzolan, hydraulic lime and gypsum or mixtures thereof may be used as the hydraulically binding component. Water or aqueous solutions, such as salt solutions, acid-containing solutions or alkali-containing solutions may be used as the hardener component.

Preferably, the inorganic multi-component mass is an inorganic fire-protection foam or insulating foam with at least one hydraulically binding component in powder form, a foaming component and a foam stabilizer. Cements, especially Portland cement, trass, pozzolan, hydraulic lime and gypsum or mixtures thereof may again be used as the hydraulically binding component. The foaming component may be formed from an alkali metal or alkaline earth carbonate or bicarbonate as the powder component and an acid as the liquid component. Alternatively or additionally, the foaming component may comprise an oxygen carrier and a catalyst. In particular, hydrogen peroxide in aqueous solution may be used as the oxygen carrier and liquid foaming component. The catalyst may comprise manganese dioxide, MnO₂, in powder form. Such multi-component foam systems are known from EP 2 045 227 A1, to which reference is made herewith.

All powdered components of the foam system may be presented together in the foldable plastic container. The liquid foam and hardener components may be supplied in separate packaging.

The foldable plastic container may have any desired shape and/or configuration. For example, the plastic container may be formed as a stand-up bag, tubular bag or flat bag. The production of these systems is known in principle to the person skilled in the art. The bottom region of stand-up bags is usually made with a W-type fold, which expands in the bottom region during filling of the chamber and ensures a secure base for the film bag. Flat bags are usually formed by placing two plastic films one on top of the other and welding the films around the borders. Tubular bags are obtained by injecting the plastic films from round nozzles to form a film tube and welding the ends of the tube on the bottom side or clamping the ends of the tube with a metal or plastic clip.

The shape of the plastic container may be cubic, pillow-shaped, pyramidal or cylindrical, with round or cylindrical base face. Particularly preferably, the foldable plastic container is a flat-pack canister, such as is known, for example, for beverage packs and liquid foods.

The wall of the foldable plastic container preferably has a wall thickness that is sufficient to withstand the mechanical stresses during transportation of the plastic container and mixing of the reactive components in the plastic container. Preferably, the wall thickness of the plastic container lies in the range of 0.05 mm to 0.8 mm, preferably of 0.1 mm to 0.3 mm.

The wall of the plastic container may be structured in one or more plies as well as oriented by stretching. Preferred materials for the plastic container are polyethylene, polypropylene, polystyrene, polyamide, polyurethane and polyvinyl acetate as well as mixtures and copolymers thereof. In addition, the wall of the plastic container may be metal-coated, preferably aluminum-coated, or may have an aluminum-foil layer.

According to a further embodiment of the inventive packaging system, the foldable plastic container may have a reinforcing and preferably flexible sheath, preferably a sheath of a fabric, open-mesh knitware or a flexible bracing structure, such as a flexible film container, for example. The sheath may be formed as a separate pouch or case, into which the foldable plastic container may be inserted. In this case, the foldable plastic container may be designed as a lining of the sheath with correspondingly thin wall thickness.

Preferably, the foldable plastic container has at least one handle, on which the plastic container can be held during the mixing process comprising shaking of the solid and liquid components in the plastic container. The at least one handle may also be disposed on the sheath.

The at least one opening of the foldable plastic container is preferably formed as a screw cap, hose connector or stopcock. A screw cap may also function as a connector for a cartridge nozzle or nozzle tip, with which the curable mass may be discharged from the plastic container in a manner appropriate for the desired purpose of use at the point of application.

A hose connector makes it possible to attach an extension hose, with which the curable mass can be filled even into poorly accessible openings. A stopcock is suitable for dispensing of flowable masses at various points of application and it prevents unwanted emergence of the mass from the plastic container during use.

According to a further embodiment, the plastic container may have several closable openings, for example one opening for filling the powdered reactive component and/or the liquid hardener component and a further opening for discharging the curable mass. The opening for discharging the curable mass may be formed by a nozzle tip or plastic socket, preferably tapering conically or sharply, welded into the plastic container. If necessary, the nozzle tip or socket may also be extended by slipping on a further plastic tip. Preferably, the nozzle tip or plastic socket is closed at its free end and, depending on the desired size of nozzle opening, will be cut to size at the point of application or may be broken off at a provided zone of weakness, such as a tear notch or an annular predetermined breaking point. Hereby no scissors or knives are needed. In this way, filling of openings in the building or of joints is possible rapidly, easily and inexpensively.

Moreover, the opening for discharging the curable mass may be formed by a socket molded in one piece onto the plastic container. The socket may be tubular or may taper conically or sharply toward its free end. A screw cap, on which a cartridge nozzle, for example, may be attached, may be provided at the free end of the socket. Particularly preferably, the socket is provided at its free end with a weak zone, such as a tear seam, for example, to permit tearing of the socket without tools. In this way, even openings that are difficult to access can be filled rapidly, simply and inexpensively with the multi-component mass.

According to a further preferred embodiment, the mixing elements have a maximum diameter of 5 mm to 50 mm, preferably 8 mm to 40 mm, and/or a weight of 2 g to 30 g, preferably 2 g to 20 g. These sizes and weights of the mixing elements are particularly well suited for intermixing during shaking of the solid and liquid components in the plastic container for formation of the curable multi-component mass.

The plastic container may further have a screen or coarse-meshed sieve with appropriate mesh size disposed in front of the opening, in order to hold back the mixing elements during discharge of the mass from the plastic container, without blocking the opening. Smaller mixing elements may remain in the curable multi-component mass without loss of quality, provided they are able to pass the opening.

Preferably, the powdered reactive mass and the mixing elements fill at least approximately 20%, preferably at least approximately 30% and particularly preferably at least approximately 40% of the total volume of the plastic container. For good intermixing of the solid and liquid components, preferably an air volume is provided in the plastic container. Preferably, the air volume amounts to approximately 20% to 80% of the total volume of the plastic container, more preferably approximately 25% to 75%, and particularly preferably approximately 30% to approximately 70%. The volume of the powdered reactive mass and of the mixing elements may correspondingly amount to up to 80% of the total volume of the plastic container, preferably 30% to 80%, more preferably 35% to 70% and even more preferably 40 to 60%.

Subject matter of the invention is further a use of the packaging system described hereinabove for packaging and/or processing of a curable multi-component mass, and especially of a curable inorganic multi-component mass, preferably an inorganic multi-component foam system.

To produce the curable multi-component mass, firstly a reactive powder component of the multi-component mass is supplied, if necessary together with mixing elements, in a foldable plastic container. The hardener component is added to the reactive component in the plastic container and the plastic container is closed.

Optionally, further solid or liquid components may be added in addition to the hardener component. Thereupon the liquid and solid components in the plastic container are mixed by shaking and/or agitating and/or kneading, with formation of the curable multi-component mass. As soon as the mixing process is completed, the plastic container is folded together to expel the curable multi-component mass out of the opening provided in the plastic container and into the opening to be filled in the building.

The plastic container with the powdered reactive mass may be used as a prepackaged product in the form of the packaging system described hereinabove, with which the separately packaged hardener components may also be enclosed. The curable multi-component mass is then processed using the packaging system described hereinabove. It is also possible to measure out the powdered component and to fill it into the plastic container at the point of application.

Using the inventive packaging system, it is possible in particular to produce a foam-in-place foam from an inorganic multi-component foam system, wherein the solid inorganic powder component is supplied in the plastic container and the liquid foaming component for the solid inorganic powder component is supplied in a separate package. The powder component is mixed in the plastic container with the liquid foaming component. After the powder component and the foaming component have been mixed, the closed opening is opened once again. The mixture or the already partly formed foam present in the plastic container is discharged from the opening and introduced into an opening to be filled in the building. The volume formed by the gases evolved during the process of mixing of the foaming component and the powder component in the closed plastic container should not be larger than the volume still additionally present in the plastic container. In order to reduce or even prevent spattering during filling of the foam into the opening, it is possible if necessary to fold the plastic container together partly after the powder component and the foaming component have been mixed and if necessary after a filling socket has been mounted, so that the air volume present in the plastic container is decreased.

The inorganic multi-component foam system is preferably a two-component foam system, and particularly preferably a fire-protection foam.

By folding the plastic container together, the foam formed from the foam system may then be discharged from the opening and introduced into the opening to be filled and also further expanded therein. The use of nozzle tips with a sharply tapering expulsion opening and a predetermined opening cross section permits selective introduction of the foam system even into narrow gaps with poor accessibility. The nozzle tips may be provided with weak zones, so that no scissors or knives are needed to open the nozzle tips. In this way, openings in the building can be filled rapidly, simply and inexpensively with the foam system. Flexible hose attachments are also helpful for filling poorly accessible building openings reliably.

Further features and advantages of the invention will become apparent from the description hereinafter of a preferred embodiment and from the following drawings, to which reference is made. In the drawing:

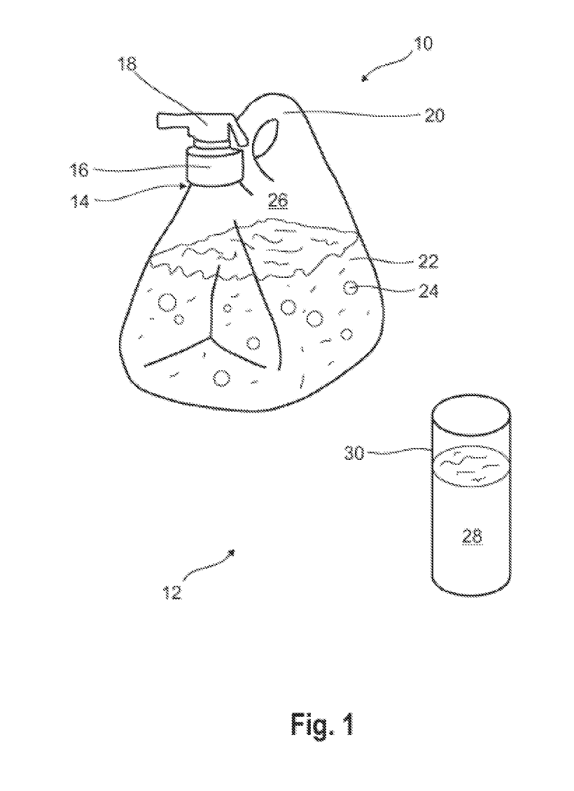

FIG. 1 shows a schematic diagram of the inventive packaging system according to a first embodiment.

Plastic container 10, illustrated in FIG. 1, of the inventive packaging system 12 is formed as a foldable stand-up film bag with a closable opening 14. In the embodiment shown here, opening 14 is closed with a screw cap 16, to which a stopcock 18 is attached. Plastic container 10 further has a handle 20 molded in one piece onto plastic container 10.

Powdered reactive component 22 of a curable inorganic multi-component mass is filled into plastic container 10. Furthermore, large-grained mixing elements 24 in the form of stones or gravel are distributed in powdered component 22. An air volume 26, which amounts to approximately 40% of the total volume of plastic container 10, is present above powdered component 22.

The stones used as mixing elements 24 have a maximum diameter of 10 mm to 40 mm and/or a weight of 2 g to 20 g.

Metal ball bearings or glass marbles, preferably with a diameter of 8 mm to 30 mm and/or a weight of 2 to 20 g may also be used as mixing elements 24.

Instead of stopcock 18, a cartridge nozzle attached to screw cap 16 may be provided, or screw cap 16 may have a port for an extension hose.

Powder component 22 preferably comprises a hydraulically binding binder based on gypsum or cement mortar, as well as, optionally, the solid components of a foaming system, such as an alkali metal or alkaline earth carbonate and/or a catalyst for release of oxygen from an oxygen carrier. The grain size distribution of powdered component 22 is preferably d90≤200 μm, i.e. approximately 90% of all particles of the powdered component have a grain size of 200 μm or smaller. The powdered component may also contain fibers with a length of approximately 1 to 6 mm and a fiber diameter of 10 to 30 μm.

Liquid hardener component 28 provided for mixing with powdered component 22 may be supplied in a separate package 30. Hardener component 28 preferably comprises water as well as, optionally, the liquid or dissolved components of a foaming system, such as an acid and/or hydrogen peroxide.

The curable multi-component mass is preferably supplied as a foam-in-place foam, which is used as an inorganic fire-protection foam or insulating foam.

To produce the curable multi-component mass, screw cap 16 is opened and liquid hardener component 28 is added to powdered component 22 in plastic container 10. During production of a foam-forming mass, part of air volume 26 may be removed from plastic container 10 by folding plastic container 10 together. Then plastic container 10 is closed once again with screw cap 16. Solid inorganic powdered component 22 is mixed with liquid hardener component 28 by shaking and/or agitating and/or kneading, with formation of the curable multi-component mass. During shaking, plastic container 10 may be held by handle 20. Any overpressure developed by foaming of the mass may also be relieved by opening stopcock 18.

After powdered and liquid components 22, 28 have been mixed, screw cap 16 is opened and a cartridge nozzle is mounted on screw cap 16. By folding plastic container 10 together, the foamed multi-component mass is discharged from plastic container 10 via the cartridge nozzle and introduced directly into the opening to be filled in the building. There the multi-component mass may be subsequently shaped, further foamed and cured.

1: A packaging system for a curable multi-component mass, the packaging system comprising:
a plastic container, and
a reactive component of the multi-component mass, which is present in the plastic container,
wherein the plastic container is a foldable plastic container with at least one closable opening, and
wherein the reactive component is present as powder and fills only part of a total volume of the plastic container.

2: The packaging system according to claim 1, which further comprises:
a hardener component, which is
separately supplied to the plastic container.

3: The packaging system according to claim 2, wherein
the multi-component mass is present in the plastic container and is an organic mass comprising at least one member selected from the group consisting of an epoxide, a (meth)acrylate, and a polyurethane.

4: The packaging system according to claim 2, wherein
the multi-component mass is present in the plastic container and is an inorganic multi-component mass, and
wherein the reactive component is a hydraulically binding component of the multi-component mass.

5: The packaging system according to claim 4, wherein
the hardener component comprises water.

6: The packaging system according to claim 4, wherein
the multi-component mass is an inorganic fire-protection foam or insulating foam.

7: The packaging system according to claim 1, wherein
the foldable plastic container has a reinforcing sheath.

8: The packaging system according to claim 1, wherein
the at least one closable opening is formed as a screw cap, hose connector, or stopcock.

9: The packaging system according to claim 1, wherein
the at least one closable opening has a port for a nozzle tip.

10: The packaging system according to claim 1, further comprising:
a mixing element, which is present in the plastic container.

11: The packaging system according to claim 10, wherein
the mixing element has a maximum diameter of 5 mm to 50 mm, or
has a weight of 2 g to 30 g, or
has a maximum diameter of 5 mm to 50 mm and has a weight of 2 s, to 30 g.

12: The packaging system according to claim 1, wherein
the reactive mass fills up to 80% of a total volume of the plastic container.

13. (canceled)

14: A method for producing a curable multi-component mass, the method comprising:
supplying a reactive component of a multi-component mass into a packaging system comprising a foldable plastic container,
adding a hardener component to the foldable plastic container having the reactive component present therein,
closing the foldable plastic container,
mixing, by shaking, the reactive component and the hardener component in the foldable plastic container to form the curable multi-component mass, and
expelling the curable multi-component mass from an opening of the foldable plastic container by folding the plastic container together.

15: The method according to claim 14, wherein
the packaging system comprises:
the foldable plastic container, and
a reactive component of the curable multi-component mass, which is present in the foldable plastic container,
wherein the plastic container has at least one closable opening, and
wherein the reactive component is present as powder and fills only part of a total volume of the foldable plastic container.

16: The method according to claim 14, wherein the curable multi-component mass is an inorganic curable multi-component mass.

17: The packaging system according to claim 10, wherein
the reactive mass and the mixing element, together, fill up to 80% a total volume of the plastic container.

18: The packaging system according to claim 4, wherein
the multi-component mass is an inorganic fire-protection foam.

19: The packaging system according to claim 4, wherein
the multi-component mass is an insulating foam.
